(19) United States
(12) Patent Application Publication
(10) Pub. No.: US 2002/0088351 A1
(43) Pub. Date: Jul. 11, 2002

(54) Extraction system and a component therefor

(76) Inventors: James Joseph Flannery, Derbyshire (GB); Gary Steven Neale, Worcestershire (GB)

Correspondence Address: SMITH-HILL AND BEDELL, 12670 N W BARNES ROAD, SUITE 104, PORTLAND, OR, 97229

(21) Appl. No.: 10/004,324

(22) Filed: Nov. 14, 2001

(30) Foreign Application Priority Data
Mar. 2, 1999 (GB) 9904651.8

(51) Int. Cl. A23N 1/00; A23B 5/00

(52) U.S. Cl. 99/495; 99/510

(57) ABSTRACT

An extraction system comprises a canopy for receiving fumes. An aperture is defined in the top of the canopy, and dusting extends from the canopy, in communication with the fumes at the aperture, to an in-line extractor fan. Further ducting extends from the in-line extractor fan to an external extractor fan. A path for the extraction of fumes by the system is defined by the inner surfaces of the canopy, the ductings and the casings of the extractor fans. The inner surfaces of each of these components are coated with a non-stick, heat resistant material such as polytetrafluoroethene (PTFE).

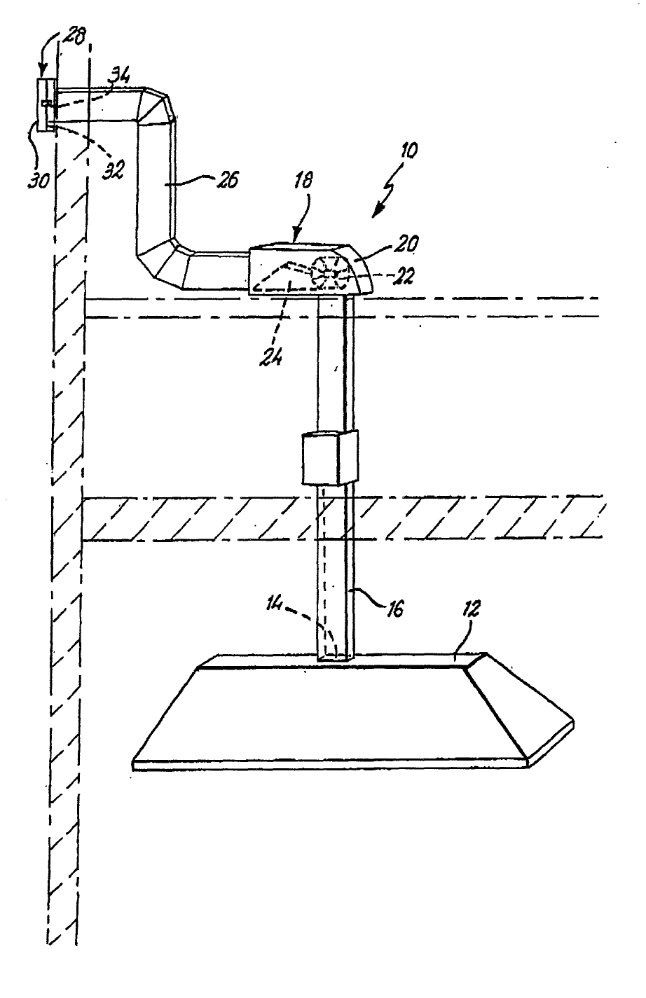

### FIELD OF INVENTION

This invention relates to components for extraction systems and to the extraction systems themselves.

### DESCRIPTION OF THE PRIOR ART

The use of fume extraction systems in commercial kitchens is well known. These extraction systems consist of canopies arranged over cookers to receive hot gases and grease from the cooking, ducting extending from the canopies to a region external of the building and extractor fans to drive the fumes through the extraction system. One problem with such extraction systems is that they present a significant fire risk and need to be cleaned on a regular basis.

### SUMMARY OF THE INVENTION

According to one aspect of this invention there is provided a component for an extraction system comprising a surface or an element adapted to define, or he arranged in, a path for matter being extracted, said surface or element being coated with a non-stick material

According to another aspect of this invention there is provided a method of providing a flame resistant component of an extraction system comprising coating with a non-stick material a surface or an element of the component, wherein said surface or element is adapted to define, or be arranged in, a path for matter being extracted.

According to another aspect of the invention there is provided the use of a non-stick material as a coating for a surface or an element of a component of an extraction system wherein said surface or element is adapted to define or be arranged in, a path for matter being extracted.

The component may be in the form of a canopy, a conduit or impeller means to drive said matter through the extraction system, Where the component is a canopy or a conduit, the inner surface thereof preferably defines said path and at least said inner surface is coated with said material. Where the component is an impeller means, for example, an extractor fan which may be an in-line extractor fan or an external fan, substantially all of the element thereof that comes into contact with the matter being extracted may be coated with said material, for example, impeller or fan blades, the inner surface of the casing thereof.

The non-stick material is preferably also a heat resistant material, and is preferably a flame retardent material. The non-stick material may a fluorinated material, suitable a polymeric fluorinated material. Preferably, the non-stick material is a fluorocarbon polymeric material, for example, polytetrafluroethene. A suitable such material is sold under the trade mark TEFLON.

According to another aspect of this invention there is provided an extraction system comprising a plurality of components as described above

### BRIEF DESCRIPTION OF THE DRAWINGS

An embodiment of the invention will now be described by way of example only with reference to the accompanying drawing which is a diagrammatic representation of an extraction system.

### DETAILED DESCRIPTION OF A PREFERRED EMBODIMENT

Referring to the drawing, there is shown an extraction system generally designated 10 which comprises a canopy 12 for receiving fumes (for example hot air gases and grease particles produced during cooking processes). An aperture 14 is defined in the top of the canopy 12, and a conduit in the form of ducting 16 extends from the canopy 12 in communication with the fumes at the aperture 14. The ducting 16 extends to an in-line extractor fan 18 comprising a casing housing a fan 22 driven by a motor 24. A second conduit in the form of further ducting 26 extends from the in-line extractor fan 18 to an external extractor fan 28 comprising a casing 30, a fan 32 and a motor 34.

A path for the extraction of fumes by the system 10 is defined by the inner surfaces of the canopy 12, the ducting 16, the casing 20, the ducting 26 and the casing 30. The inner surfaces of each of these components is coated with a non-stick, heat resistant material such as polytetrafluoroethene (PTFE). Suitable such material is sold under the wade mark TEFLON.

Also, components in the form of elements of the extractor fans, for example the blades of the fans 22, 32 and the motors 24, 34 are also coated with PTFE.

The coating of the inner surfaces, and the elements as described above means that any part of the extraction system which comes into contact with the fumes being extracted is coated with the PTFE which prevents or substantially reduces the amount of matter That sticks to the surfaces or to the elements, thereby reducing the risk of fire, In addition, since PTFE is itself heat resistant and flame retardant, the risk of fire is further reduced.

The preferred embodiment of the present invention has the advantage that it facilitates cleaning, it provides a reduced fire hazard. Also, since the non-stick properties of PTFE will prevent or substantially reduce the build up of bacteria it will reduce the danger of the spread of diseases, such as legionaires disease.

Various modifications can be made without departing from the scope of the invention.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A component for an extraction system comprising a surface or an element adapted to define, or be arranged in, a path for matter being extracted, said surface or element being coated with a non-stick material.

2. A component according to claim 1 in which the component is in the form of a canopy.

3. A component according to claim 1 in which the component is in the form of a conduit.

4. A component according to claim 1 in which the component is in the form of an impeller means to drive said matter through the extraction system.

5. A component according to claim 4 in which the impeller means is an extractor fan.

6. A component according to claim 5 in which the extractor fan is an in-line extractor fan or an external fan.

7. A component according to claim 2 in which the inner surface thereof defines said path and at least said inner surface is coated with said material.

8. A component according to claim 4 in which substantially all of the element thereof that comes into contact with the matter being extracted is coated with said material.

9. A component according to claim 1 in which the non-stick material is also a heat resistant material.

10. A component according to claim 9 in which non-stick material is a flame retardent material.

11. A component according to claim 9 in which the non-stick material is a fluorinated material.

12. A component according to claim 11 in which the non-stick material is a polymeric fluorinated material.

13. A component according to claim 12 in which the non-stick material is a fluorocarbon polymeric material.

14. A component according to claim 13 in which the non-stick material is a polytetrafluoroethene.

15. An extraction system comprising a plurality of components according to claim 1.

16. A method of providing a flame resistant component of an extraction system comprising coating with a non-stick material a surface or an element of the component, and arranging said surface or element to define, or be arranged in, a path for matter being extracted.

17. A method according to claim 16 in which the component is according to claim 1.

18. The use of a non-stick material for coating a surface or an element of a component of an extraction system wherein said surface or element is adapted to define or be arranged in, a path for matter being extracted.

19. The use according to clam 18 in which the component is according to claim 1.
